(19) United States
(12) Patent Application Publication
(10) Pub. No.: US 2025/0059353 A1
(43) Pub. Date: Feb. 20, 2025

(54) SILICONE RUBBER COMPOSITION FOR SEALING MATERIAL, SEALING MATERIAL, AND BATTERY

(71) Applicant: UCHIYAMA MANUFACTURING CORP., Okayama (JP)

(72) Inventors: Otone ESUMI, Okayama (JP); Yuji YASUFUKU, Okayama (JP); Takami KAWABATA, Okayama (JP); Tatsuo KATAYAMA, Okayama (JP)

(21) Appl. No.: 18/723,937

(22) PCT Filed: Nov. 7, 2022
(86) PCT No.: PCT/JP2022/041314

§ 371 Date: Jun. 25, 2024

(30) Foreign Application Priority Data
Dec. 28, 2021 (JP) 2021-214907

(51) Int. Cl. C08K 7/04; C08K 5/14; C09K 21/14; H01M 10/658; H01M 50/204; H01M 50/24; H01M 50/293

(52) U.S. Cl. CPC C08K 7/04; C08K 5/14; C09K 21/14; H01M 10/658; H01M 50/204; H01M 50/24; H01M 50/293; C08K 2201/004

(57) ABSTRACT

Provided is a sealing material silicone rubber composition that has higher flame retardancy than a conventional sealing material silicone rubber composition. A silicone rubber composition in accordance with an aspect of the present disclosure contains a flame retardant silicone rubber compound and a fibrous flame retardant, the fibrous flame retardant being contained in an amount of 5 parts by weight to 60 parts by weight assuming that the flame retardant silicone rubber compound is contained in an amount of 100 parts by weight, and the flame retardant silicone rubber compound being rated as V-0 or higher according to UL94 standard.

### TECHNICAL FIELD

The present invention relates to a silicone rubber composition for a sealing material (hereinafter referred to as a “sealing material silicone rubber composition”), a sealing material, and a battery.

### BACKGROUND ART

A composition obtained by adding various additives to silicone rubber in order to impart industrially desirable physical properties to the silicone rubber is conventionally proposed (for example, see Patent Literatures 1 to 3).

### CITATION LIST

### Patent Literature

### [Patent Literature 1]

Japanese Patent Application Publication, Tokukaishou, No. 48-080656

### [Patent Literature 2]

Japanese Patent Application Publication, Tokukaishou, No. 57-209980

### [Patent Literature 3]

Japanese Patent Application Publication, Tokukaishou, No. 60-182199

### SUMMARY OF INVENTION

### Technical Problem

For example, in a case where silicone rubber is employed in a sealing material for use in a battery, flame retardancy is preferably imparted to the silicone rubber. As a result of study by the inventors of the present invention, it has turned out that an existing flame retardant silicone rubber compound still has room for improvement in flame retardancy.

An aspect of the present invention has an object to provide a sealing material silicone rubber composition that has higher flame retardancy than a conventional sealing material silicone rubber composition.

### Solution to Problem

In order to attain the object, a silicone rubber composition in accordance with an aspect of the present invention
contains a flame retardant silicone rubber compound and a fibrous flame retardant,
the fibrous flame retardant being contained in an amount of 5 parts by weight to 60 parts by weight assuming that the flame retardant silicone rubber compound is contained in an amount of 100 parts by weight, and
the flame retardant silicone rubber compound being rated as V-0 or higher according to UL94 standard.

### Advantageous Effects of Invention

An aspect of the present invention provides a sealing material silicone rubber composition that has higher flame retardancy than a conventional sealing material silicone rubber composition.

### BRIEF DESCRIPTION OF DRAWINGS

FIG. 1 is a schematic view illustrating an example of a battery in which a sealing material in accordance with an aspect of the present invention is used.

### DESCRIPTION OF EMBODIMENTS

The following description will discuss an embodiment of the present invention in detail. However, the present invention is not limited to the following embodiment, but can be altered in various ways within the description. An embodiment derived from an appropriate combination of technical means disclosed in different embodiments is also encompassed in the technical scope of the present invention.

Any numerical range expressed as “A to B” herein means “not less than A and not more than B”.

### [1. Sealing Material Silicone Rubber Composition]

A sealing material silicone rubber composition in accordance with an aspect of the present invention contains a flame retardant silicone rubber compound and a fibrous flame retardant. The following description will discuss each of components.

### [1.1. Flame Retardant Silicone Rubber Compound]

The flame retardant silicone rubber compound is a composition obtained by blending various additives with silicone rubber so as to impart flame retardancy to the silicone rubber. The flame retardant silicone rubber compound has flame retardancy that is rated as V-0 or higher according to UL94 standard.

The UL94 standard is a standard for evaluating flame retardancy of plastic products and is widely adopted worldwide. A rating of the UL94 standard includes 5VA, 5VB, V-0, V-1, V-2, and HB in decreasing order of flame retardancy. Thus, the flame retardant silicone rubber compound is rated as 5VA, 5VB, or V-0 according to the UL94 standard. In an embodiment, the flame retardant silicone rubber compound is rated as V-0 according to the UL94 standard. Since a UL94 standard test method is well known among persons skilled in the art, a description thereof is omitted.

The flame retardant silicone rubber compound contains the silicone rubber. In an embodiment, the silicone rubber is an organopolysiloxane resin. In the organopolysiloxane resin, a proportion of units which are among all units contained in a main chain of the organopolysiloxane resin and each of which has an organopolysiloxane structure is preferably not less than 50%, more preferably not less than 70%, and even more preferably not less than 90%. Specific examples of the silicone rubber include methyl silicone rubber, vinyl methyl silicone rubber, phenyl methyl silicone rubber, and silicone fluoride rubber. Only one of these silicone rubbers may be contained, or two or more of these silicone rubbers may be contained. In an embodiment, the flame retardant silicone rubber compound contains vinyl methyl silicone rubber. Examples of an additive contained in the flame retardant silicone rubber compound include platinum, platinum compounds, iron oxides, triazole-based compounds, and aluminum hydroxides. Only one of these additives may be contained, or two or more of these silicone rubbers may be contained. Many products of the flame retardant silicone rubber compound are commercially available, and there are many patent literatures related to the flame retardant silicone rubber compound. Thus, a description of a detailed composition of the flame retardant silicone rubber compound is omitted.

Examples of the flame retardant silicone rubber compounds that are commercially available include: SILASTIC (trademark (TM)) SH502U, SH502U A/B, and SH1447 U A (each available from Dow Toray Co., Ltd.); KE-5620W-U, KE-5620BL-U, KE-5612E-U, KE-3494, KE3490, KE3467, KE-4890, KE-40RTV, KE-1831, KE-1867, KE-1891, KE-1204-LTV, KE-1292, KE-1800, and KE-1802 (each available from Shin-Etsu Chemical Co., Ltd.); ELASTOSIL (R) LR 3011/50 FR, LR 3001/55 FR, LR 3001/60 FR, and LR 3170/40 (each available from Wacker Asahikasei Silicone Co., Ltd); and TSE2186U, TSE2183U, TSE2187U, TSE2184U, TCM5406U, and XE20-A7016 (each available from Momentive Performance Materials Japan LLC).

Examples of a patent literature that discloses the flame retardant silicone rubber compound include Japanese Patent Application Publication, Tokukai, No. 2004-149693, Japanese Patent Application Publication, Tokukai, No. 2006-182911, and Japanese Patent Application Publication, Tokukai, No. 2009-144024.

### [1.2. Fibrous Flame Retardant]

The fibrous flame retardant means a flame retardant that has a fibrous form. The expression “fibrous form” is herein intended to mean a shape having an aspect ratio (length/diameter) of not less than 3.

The inventors of the present invention have found that the silicone rubber composition obtained by combining the flame retardant silicone rubber compound and the fibrous flame retardant has higher flame retardancy than the flame retardant silicone rubber compound itself. However, blending of flame retardants (such as a phosphorus-based flame retardant and a particulate inorganic flame retardant) other than the fibrous flame retardant exhibited no effect of improvement in flame retardancy (for details, see Examples of the present application). That is, it can be said that selection of the fibrous flame retardant among flame retardants which have various types has led to exhibition of an effect of the present invention.

An average fiber length of the fibrous flame retardant has a lower limit that is preferably not less than 50 μm, more preferably not less than 70 μm, and even more preferably not less than 100 μm. The average fiber length of the fibrous flame retardant has an upper limit that is preferably not more than 1,500 μm, more preferably not more than 1,000 μm, and even more preferably not more than 800 μm. An average diameter of the fibrous flame retardant has a lower limit that is preferably not less than 0.05 μm, more preferably not less than 0.1 μm, even more preferably not less than 0.15 μm, and particularly preferably not less than 0.2 μm. The average diameter of the fibrous flame retardant has an upper limit that is preferably not more than 10.0 μm, more preferably not more than 5.0 μm, even more preferably not more than 3.0 μm, and particularly preferably not more than 1.0 μm. The aspect ratio has a lower limit that is preferably not less than 5, more preferably not less than 50, even more preferably not less than 100, and particularly preferably not less than 150. The aspect ratio has an upper limit that is preferably not more than 5,000, more preferably not more than 4,000, even more preferably not more than 1,000, particularly preferably not more than 500, and still more preferably not more than 250. A shot content of the fibrous flame retardant has a lower limit that may be not less than 0.1% by weight, not less than 0.01% by weight, or substantially not less than 0% by weight, relative to a weight of the fibrous flame retardant. The shot content of the fibrous flame retardant has an upper limit that is preferably not more than 5% by weight, more preferably not more than 1% by weight, and even more preferably not more than 0.5% by weight, relative to the weight of the fibrous flame retardant. Note here that a shot means a non-fibrous particle which has not been made into fibers in a process for producing the fibrous flame retardant.

Examples of the fibrous flame retardant include artificial mineral fiber, natural mineral fiber, and synthetic organic fiber. Examples of the artificial mineral fiber include rock wool, stone wool, slug wool, mineral wool, glass wool, and mineral glass wool. Examples of the natural mineral fiber include wollastonite and potassium titanate fiber. Examples of the synthetic organic fiber include aramid fiber. Among these examples of the fibrous flame retardant, artificial mineral fiber is preferable. Among the examples of the artificial mineral fiber, rock wool is preferable. In an embodiment, the fibrous flame retardant is an inorganic substance. In an embodiment, the fibrous flame retardant is not asbestos.

### [1.3. Other Component(s)]

A sealing material silicone rubber composition in accordance with an embodiment of the present invention may contain a component(s) other than the components described above. Examples of such a component include a curing agent.

The curing agent is a component that imparts rubber elasticity to the silicone rubber composition. A person skilled in the art could select the curing agent as appropriate in accordance with a reaction mechanism for imparting rubber elasticity. Examples of the reaction mechanism carried out by the curing agent include a crosslinking reaction, a condensation reaction, and an addition reaction.

An organic peroxide can be used to impart rubber elasticity through the crosslinking reaction. Examples of the organic peroxide include benzoyl peroxide, 2,4-dichlorobenzoyl peroxide, dicumyl peroxide, cumyl-t-butyl peroxide, 2,5-dimethyl-2,5-di-t-butyl peroxyhexane, and di-t-butyl peroxide.

A silicon-containing crosslinking agent and a curing catalyst can be used to impart rubber elasticity through the condensation reaction. Examples of the silicone-containing crosslinking agent include alkoxysilanes, acetoxysilanes, and cyclic siloxanes. Examples of the curing catalyst include metal carboxylates and organotin compounds.

Organohydrogenpolysiloxane and a platinum-based catalyst can be used to impart rubber elasticity through the addition reaction. Organohydrogenpolysiloxane is polyorganosiloxane in which two or more hydrogen atoms per molecule on average are bonded to a silicone atom.

The silicone rubber composition may contain oil. Among oils, silicone oil is preferable, and modified silicone oil is more preferable. The silicone oil means oil that contains polyorganosiloxane as a main component. The modified silicone oil means silicone oil in which a methyl group contained in dimethyl silicone oil is partially substituted with another functional group. Examples of the modified silicone oil include amino-modified silicone oil, epoxy-modified silicone oil, carboxyl-modified silicone oil, carbinol-modified silicone oil, (meth)acrylic-modified silicone oil, mercapto-modified silicone oil, phenol-modified silicone oil, polyether-modified silicone oil, methylstyryl-modified silicone oil, alkyl-modified silicone oil, higher fatty acid ester-modified silicone oil, higher alkoxy-modified silicone oil, fluorine-modified silicone oil, and aralkyl-modified silicone oil. The modified silicone oil includes non-reactive modified silicone oil and reactive modified silicone oil. Among these modified silicone oils, non-reactive modified silicone oil is preferable.

The silicone rubber composition may contain various additives known in this technical field. Examples of such additives include: reinforcing fillers (such as silica, diatomaceous earth, quartz powder, mica, and titanium oxide); extending fillers (such as diatomaceous earth, quartz powder, mica, clay, glass beads, and aluminum oxide); heat resistance improvers (such as carbon black, rouge, alkali metal oxides, and alkaline earth metal oxides); and pigments.

### [1.4 Makeup of Silicone Rubber Composition]

A content of the flame retardant silicone rubber compound in the silicone rubber composition has a lower limit that is preferably not less than 50% by weight, and not less than 55% by weight, relative to a total weight of the silicone rubber composition. The content of the flame retardant silicone rubber compound in the silicone rubber composition has an upper limit that can be, for example, not more than 98% by weight.

A content of a silicone rubber polymer in the silicone rubber composition has a lower limit that is preferably not less than 10% by weight, more preferably not less than 15% by weight, and even more preferably not less than 18% by weight, relative to the total weight of the silicone rubber composition. The content of the silicone rubber polymer in the silicone rubber composition has an upper limit that can be, for example, not more than 98% by weight.

In a case where the silicone rubber composition contains a rubber component(s) other than the silicone rubber, a ratio of the silicone rubber to a total of the rubber component(s) is preferably not less than 50% by weight, more preferably not less than 70% by weight, and even more preferably not less than 90% by weight. In an embodiment, the silicone rubber composition contains no rubber component other than the silicone rubber. Examples of the rubber component(s) other than the silicone rubber include fluorine rubber (FKM), natural rubber (NR), styrene-butadiene rubber (SBR), isoprene rubber (IR), butadiene rubber (BR), chloroprene rubber (CR), acrylonitrile-butadiene rubber (NBR), butyl rubber (IIR), ethylene-propylene rubber (EPM), ethylene-propylene-diene rubber (EPDM), urethane rubber (U), ethylene acrylic rubber (AEM), and acrylic rubber (ACM).

An amount of the fibrous flame retardant contained in the silicone rubber composition has a lower limit that is not less than 5 parts by weight, preferably not less than 15 parts by weight, and more preferably not less than 20 parts by weight, assuming that the flame retardant silicone rubber compound is contained in the silicone rubber composition in an amount of 100 parts by weight. In a case where the lower limit of the amount of the fibrous flame retardant contained in the silicone rubber composition is in the above range, the silicone rubber composition tends to have sufficient flame retardancy. The amount of the fibrous flame retardant contained in the silicone rubber composition has an upper limit that is not more than 60 parts by weight, preferably not more than 50 parts by weight, more preferably not more than 45 parts by weight, and even more preferably not more than 40 parts by weight, assuming that the flame retardant silicone rubber compound is contained in the silicone rubber composition in an amount of 100 parts by weight. In a case where the upper limit of the amount of the fibrous flame retardant contained in the silicone rubber composition is in the above range, the silicone rubber composition tends to have softness suitable to serve as the sealing material.

An amount of the oil contained in the silicone rubber composition has a lower limit that is preferably not less than 0.1% by weight, more preferably not less than 0.3% by weight, and even more preferably not less than 0.5% by weight, relative to the total weight of the silicone rubber composition. The oil that is contained in the silicone rubber composition in an amount of less than 0.1% by mass may reduce processability. The amount of the oil contained in the silicone rubber composition has an upper limit that is preferably not more than 15% by weight, more preferably not more than 10% by weight, and even more preferably not more than 5% by weight, relative to the total weight of the silicone rubber composition. The oil that is contained in an amount of more than 15% by mass may excessively soften the silicone rubber composition or cause bleeding in the silicone rubber composition.

An amount of other component(s) blended could be set, as appropriate, by a person skilled in the art in accordance with common general technical knowledge. For example, the curing agent can be contained in an amount of 0.2 parts by weight to 5.0 parts by weight assuming that the flame retardant silicone rubber compound is contained in an amount of 100 parts by weight.

### [1.5. Physical Property of Silicone Rubber Composition]

The silicone rubber composition has Shore A hardness of preferably not more than 85, and more preferably not more than 80. It can be said that the silicone rubber composition which has Shore A hardness in the above range has softness suitable to serve as the sealing material. The Shore A hardness is herein measured with use of a Type A durometer based on JIS K6253. For a more specific measurement method, see Examples of the present application. Note that the Shore A hardness of the silicone rubber composition is obtained by carrying out a measurement with respect to the cured silicone rubber composition in an ordinary state (a state in which no heat resistance test or burning test has been carried out).

The silicone rubber composition that has been subjected to the heat resistance test has a permanent compression set of preferably not more than 50, and more preferably not more than 30. In a case where the silicone rubber composition that has been subjected to the heat resistance test has a permanent compression set in the above range, the silicone rubber composition can be said to have sufficient elasticity even after being exposed to high temperature. The permanent compression set after the heat resistance test is herein measured on the basis of JIS K6262. For a more specific measurement method, see Examples of the present application. Note that the permanent compression set of the silicone rubber composition after the heat resistance test is obtained by carrying out a measurement with respect to the cured silicone rubber composition.

The silicone rubber composition has higher flame retardancy than the flame retardant silicone rubber compound alone that is contained in the silicone rubber composition. The expression “has higher flame retardancy” is herein intended to mean that one or more (preferably two or more, and more preferably all) of three conditions below are satisfied. For a method for carrying out a flame retardancy test, see Examples of the present application.
A smoke occurrence time is delayed.
A flame occurrence time is delayed.
A flame duration is shortened.

### [2. Sealing Material and Battery]

A sealing material in accordance with an aspect of the present invention contains the sealing material silicone rubber composition described above. The sealing material herein means a molded product that is used while being interposed between a plurality of members. The plurality of members may be members whose relative position changes, or may be relatively stationary members. For example, the sealing material has a function to block movement of a fluid (a gas, a liquid, or a mixture of these).

A use of the sealing material is not particularly limited. The sealing material in accordance with an embodiment of the present invention has higher flame retardancy and thus is preferably used in a product that is required to have flame retardancy. Examples of such a product include batteries, vehicles, residential building materials, household electrical appliances, and mobile terminals.

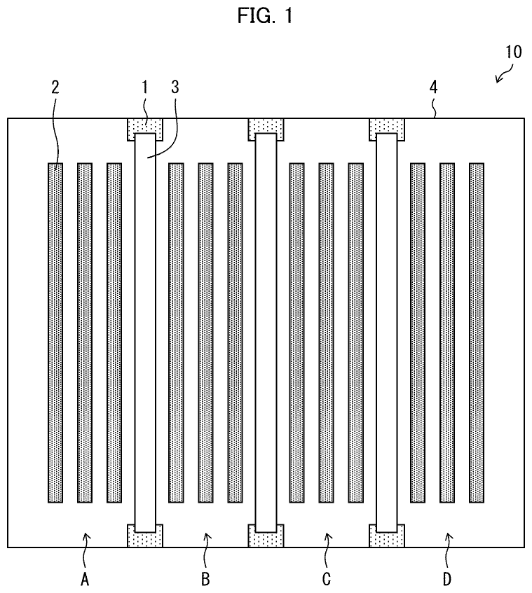

The following description will discuss, with reference to FIG. 1, an example of use in the case of application of the sealing material in accordance with an embodiment of the present invention to a battery. A battery 10 includes sealing materials 1, cells 2, heat insulating materials 3, and a container 4. The battery 10 is configured to extract electric power from the cells 2 (12 cells 2 in FIG. 1). Note that FIG. 1 does not illustrate any member for extracting electric power from the cells 2. Specific examples of the battery 10 include a nonaqueous electrolyte secondary battery (such as a lithium ion secondary battery).

The sealing materials 1 are each the sealing material in accordance with an aspect of the present invention. The cells 2 are each a power generation element including a package of, for example, a positive electrode, a negative electrode, a separator, and an electrolyte. The heat insulating materials 3 are members that prevent transmission of heat generated in the cells 2. The container 4 is a member that stores therein the sealing materials 1, the cells 2, and the heat insulating materials 3.

An inside of the container 4 is divided into a plurality of sections by the heat insulating materials 3. In FIG. 1, the inside of the container 4 is divided into four sections, which are a section A, a section B, a section C, and a section D. The cells 2 are separately provided in two or more of the plurality of sections. In FIG. 1, the cells 2 are provided in all the four sections A to D. Note, however, that there may be any section in which no cell 2 is provided. The sealing materials 1 are provided so as to close gaps between the heat insulating materials 3 and the container 4.

For example, in a case where a cell 2 provided in the section A fails and catches fire, a corresponding sealing material 1 and a corresponding heat insulating material 3 prevent spread of fire to the section B. The sealing material 1 is the sealing material in accordance with an aspect of the present invention and thus has higher flame retardancy than a conventional sealing material. Thus, the battery 10 has higher safety than a conventional battery.

### [3. Method for Producing Sealing Material Silicone Rubber Composition and Sealing Material]

A method for producing a sealing material silicone rubber composition in accordance with an aspect of the present invention is not particularly limited. For example, by kneading the components described in the [1. Sealing material silicone rubber composition] section, it is possible to produce the sealing material silicone rubber composition. A kneading machine can be used to knead the components. Examples of the kneading machine include an open-roll mixer, a kneader, a planetarium mixer, a Banbury mixer, and an extruder. A kneading temperature may be 25° C. to 200° C. A kneading time may be 1 minute to 1 hour.

A method for producing a sealing material in accordance with an aspect of the present invention is not particularly limited. For example, by molding and curing the sealing material silicone rubber composition described earlier, it is possible to produce the sealing material. Examples of a molding method include injection molding, transfer molding, compression molding, pressing, and extrusion molding. A curing temperature may be 25° C. to 200° C. A curing time may be 10 seconds to 120 minutes.

An order in which curing and molding are carried out is not particularly limited. The cured silicone rubber composition may be molded, the silicone rubber composition being subjected to a curing reaction may be molded, and a molded body after molding may be cured.

The cured molded body may be further subjected to secondary curing. A secondary curing temperature may be 25° C. to 250° C. A secondary curing time may be 30 minutes to 4 hours.

### [4. Recapitulation]

The present invention includes the following features.

<1>

A sealing material silicone rubber composition containing a flame retardant silicone rubber compound and a fibrous flame retardant,
the fibrous flame retardant being contained in an amount of 5 parts by weight to 60 parts by weight assuming that the flame retardant silicone rubber compound is contained in an amount of 100 parts by weight, and
the flame retardant silicone rubber compound being rated as V-0 or higher according to UL94 standard.
   <2>

The sealing material silicone rubber composition described in <1>, wherein the fibrous flame retardant contains at least one selected from the group consisting of artificial mineral fiber, natural mineral fiber, and synthetic organic fiber.

<3>

The sealing material silicone rubber composition described in <2>, wherein
the fibrous flame retardant contains the artificial mineral fiber, and
the artificial mineral fiber contains rock wool.
   <4>

The sealing material silicone rubber composition described in any one of <1> to <3>, wherein the fibrous flame retardant has a fiber length of 50 μm to 500 μm and a shot content of not more than 5% by weight.

<5>

The sealing material silicone rubber composition described in any one of <1> to <4>, wherein a content of the flame retardant silicone rubber compound in the sealing material silicone rubber composition is not less than 50% by weight.

<6>

The sealing material silicone rubber composition described in any one of <1> to <5>, wherein the sealing material silicone rubber composition has Shore A hardness of not more than 85.

<7>

A sealing material containing a sealing material silicone rubber composition described in any one of <1> to <6>.

<8>

A battery including a plurality of cells, a heat insulating material, a container, and a sealing material described in <7>,
the container storing therein the plurality of cells, the heat insulating material, and the sealing material,
the heat insulating material being provided so as to divide an inside of the container into a plurality of sections,
the plurality of cells being separately provided in two or more of the plurality of sections, and
the sealing material being provided so as to close a gap between the heat insulating material and the container.
   <9>

A battery including a plurality of cells, a heat insulating material, a container, and a sealing material,
the sealing material containing a sealing material silicone rubber composition described in any one of <1> to <6>.

The present invention also includes the following features.

### [A1]

A method for producing a sealing material silicone rubber composition,
including mixing a flame retardant silicone rubber compound and a fibrous flame retardant,
the fibrous flame retardant being blended in an amount of 5 parts by weight to 60 parts by weight assuming that the flame retardant silicone rubber compound is blended in an amount of 100 parts by weight, and
the flame retardant silicone rubber compound being rated as V-0 or higher according to UL94 standard.

### [A2]

A method for improving flame retardancy of a flame retardant silicone rubber compound,
including mixing a flame retardant silicone rubber compound and a fibrous flame retardant,
the fibrous flame retardant being blended in an amount of 5 parts by weight to 60 parts by weight assuming that the flame retardant silicone rubber compound is blended in an amount of 100 parts by weight, and
the flame retardant silicone rubber compound being rated as V-0 or higher according to UL94 standard.

### EXAMPLES

An embodiment of the present invention will be more specifically described below with use of Examples. Note, however, that the present invention is not limited to these Examples.

### [Materials Used]

### Flame Retardant Silicone Rubber Compound

Flame retardant silicone rubber compound A (KE-5612E-U available from Shin-Etsu Chemical Co., Ltd., vinyl methyl silicone rubber-based compound, UL94 standard: V-0)
Flame retardant silicone rubber compound B (SH502U available from Dow Toray Co., Ltd., vinyl methyl silicone rubber-based compound, UL94 standard: V-0)

### Flame Retardant

Fibrous flame retardant A (rock wool, RS490ELS-Roxul1000 available from Lapinus, fiber length: 150 μm to 250 μm, shot content: 0.2% (average))
Fibrous flame retardant B (rock wool, FS021 available from JFE Rockfiber Corp., shot content: 30% to 40%)
Fibrous flame retardant C (aramid fiber, Twaron (registered trademark) 3091 available from TEIJIN LIMITED, fiber length: 650 μm to 1,150 μm)
Phosphorus-based flame retardant (Fireguard FCX-210 available from TEIJIN LIMITED)
Inorganic flame retardant (particulate aluminum hydroxide)

### Curing Agent

Curing agent A (C-3 available from Shin-Etsu Chemical Co., Ltd., dicumyl peroxide)
Curing agent B (RC4 50P available from Dow Toray Co., Ltd., 2,5-dimetyl-2,5-bis(t-butylperoxy)hexane)

### Examples 1 to 8 and Comparative Examples 1 to 5

A vulcanized rubber sheet was produced by the following procedure. The vulcanized rubber sheet serves as a material for producing a test piece in a test described later.

1. An open-roll mixer was used to knead components shown in Table 1. A temperature during kneading was 20° C. to 100° C. A kneading time was 10 minutes to 30 minutes.
2. An unvulcanized rubber sheet was produced from a resulting kneaded material.
3. The unvulcanized rubber sheet was press-vulcanized at 165° C. for 10 minutes.
4. Furthermore, the press-vulcanized rubber sheet was subjected to secondary vulcanization at 200° C. for 4 hours. In this way, a vulcanized rubber sheet having a thickness of 2 mm was obtained.

### [Test Method]

### [1. Hardness in Ordinary State]

Shore A hardness of a silicone rubber composition not having been subjected to a heat resistance test or a burning test was measured on the basis of JIS K6253. A specific procedure is as described below.

1. Three vulcanized rubber sheets each having a thickness of 2 mm were placed on top of each other so as to be used as a test piece.
2. A Type A durometer was used to carry out a measurement at 23° C. and a relative humidity of 50%. A peak value of the durometer was regarded as the Shore A hardness.

### [2. Heat Resistance Test]

On the basis of JIS K6262, the silicone rubber composition was subjected to a heat resistance test and then measured for a permanent compression set. A specific procedure is as described below.

1. Three sheets each having a diameter of 13 mm were cut from a vulcanized rubber sheet having a thickness of 2 mm. The three sheets that were placed on top of each other were used as a test piece.
2. The test piece was compressed by 25% and kept in air at 150° C. for 70 hours.
3. Compression was released, and the permanent compression set of the silicone rubber composition was calculated. It can be said that the silicone rubber composition the permanent compression set of which has a small value has a high restoring force even after being compressed for a long time.

### [3. Dispersibility]

Dispersibility of the fibrous flame retardant was evaluated from an appearance of the silicone rubber composition. A specific procedure is as described below.

1. An unvulcanized rubber sheet after kneading produced in Examples or Comparative Examples was cut with a cutter.
2. A filler dispersion tester (Dispersion-Checker DCF50A available from M&K Co., Ltd.) was used to measure a degree of dispersion of the fibrous flame retardant in a cross-section of the cut unvulcanized rubber sheet. A measurement result was evaluated by the following criteria. A higher degree of dispersion is more preferable.
1: A degree of dispersion of less than 80%
2: A degree of dispersion of not less than 80% and not more than 90%
3: A degree of dispersion of not less than 90%

### [4. Burning Test]

The silicone rubber composition was subjected to a burning test so as to evaluate flame retardancy and shape retainability after burning. A specific procedure is as described below.

1. A sheet having a width of 10 mm and a length of 100 mm was cut from a vulcanized rubber sheet having a thickness of 2 mm, and was used as a test piece.
2. The test piece was fixed to a jig, and flame of a burner was adjusted so that a temperature at a burning part was 800° C.
3. The flame was applied to the test piece for 2 minutes. In this case, assuming that a time at which the flame started to be applied was 0 second, a time (second) at which smoke occurred and a time (second) at which flame occurred were recorded. Further, a duration (seconds) from when the flame occurred to when the flame was extinguished was also recorded.
4. After burning, deformation and appearance of the test piece were visually checked.

Criteria used to determine deformation and appearance of the test piece after the burning test are as described below.

### Deformation

1: There is large deformation.
2: There is moderate deformation.
3: There is small deformation.
4: There is no deformation (or there is only minute deformation).

### Appearance

1: Poor There are many broken pieces, peelings, fractures, crushed pieces, etc.
2: Ordinary There is a large crack.
3: Good There is a small or moderate crack.
4: Very good The test piece is merely whitish, and there is no crack (or there is only a minute crack).

TABLE 1

| | | | | Example | Example | Example | Example | Example | Example |
|---|---|---|---|---|---|---|---|---|---|
| | | | | 1 | 2 | 3 | 4 | 5 | 6 |
| Silicone | Flame retardant | Flame retardant | Part by | 100.0 | 100.0 | 100.0 | 100.0 | 100.0 | |
| rubber | silicone rubber | silicone rubber | weight | | | | | | |
| composition | compound | compound A | | | | | | | |
| | | Flame retardant | | | | | | | 100.0 |
| | | silicone rubber | | | | | | | |
| | | compound B | | | | | | | |
| | Flame retardant | Fibrous flame | | 10.0 | 20.0 | 30.0 | 40.0 | 50.0 | 40.0 |
| | | retardant A | | | | | | | |
| | | Fibrous flame | | | | | | | |
| | | retardant B | | | | | | | |
| | | Fibrous flame | | | | | | | |
| | | retardant C | | | | | | | |
| | | Organic flame | | | | | | | |
| | | retardant | | | | | | | |
| | | Inorganic flame | | | | | | | |
| | | retardant | | | | | | | |
| | Curing agent | Curing agent A | | 1.3 | 1.3 | 1.3 | 1.3 | 1.3 | |
| | | Curing agent B | | | | | | | 0.5 |
| Evaluation | Ordinary state | Shore A hardness | Point | 66 | 72 | 76 | 79 | 83 | 77 |
| | Heat resistance | Permanent | % | — | 18 | 22 | 26 | — | 26 |
| | test | compression set | | | | | | | |
| | Dispersibility | Determination | | 3 | 3 | 3 | 3 | 3 | 3 |
| | Burning test | Smoke | Second | 20 | 20 | 20 | 25 | 25 | 25 |
| | | occurrence time | | | | | | | |
| | | Flame | | 20 | 25 | 25 | 30 | 30 | 30 |
| | | occurrence time | | | | | | | |
| | | Flame duration | | 10 | 10 | 5 | 5 | 5 | 5 |

| | | | | | | |
|---|---|---|---|---|---|---|
| Deformation | 2 | 3 | 4 | 3 | 3 | 3 |
| Appearance | 2 | 3 | 4 | 4 | 4 | 4 |

| | | | | Example | Example | Example |
|---|---|---|---|---|---|---|
| | | | | 7 | 8 | 9 |
| Silicone | Flame retardant | Flame retardant | Part by | 100.0 | 100.0 | 100.0 |
| rubber | silicone rubber | silicone rubber | weight | | | |
| composition | compound | compound A | | | | |
| | | Flame retardant | | | | |
| | | silicone rubber | | | | |
| | | compound B | | | | |
| | Flame retardant | Fibrous flame | | | | |
| | | retardant A | | | | |
| | | Fibrous flame | | 30.0 | 40.0 | |
| | | retardant B | | | | |
| | | Fibrous flame | | | | 20.0 |
| | | retardant C | | | | |
| | | Organic flame | | | | |
| | | retardant | | | | |
| | | Inorganic flame | | | | |
| | | retardant | | | | |
| | Curing agent | Curing agent A | | 1.3 | 1.3 | 1.3 |
| | | Curing agent B | | | | |
| Evaluation | Ordinary state | Shore A hardness | Point | 74 | 78 | 75 |
| | Heat resistance | Permanent | % | 25 | 28 | — |
| | test | compression set | | | | |
| | Dispersibility | Determination | | 2 | 2 | 1 |
| | Burning test | Smoke | Second | 20 | 25 | 25 |
| | | occurrence time | | | | |
| | | Flame | | 25 | 30 | 25 |
| | | occurrence time | | | | |
| | | Flame duration | | 5 | 5 | 15 |

| | | | |
|---|---|---|---|
| Deformation | 4 | 4 | 4 |
| Appearance | 4 | 4 | 3 |

| | | | | Comparative | Comparative | Comparative | Comparative | Comparative |
|---|---|---|---|---|---|---|---|---|
| | | | | Example 1 | Example 2 | Example 3 | Example 4 | Example 5 |
| Silicone | Flame retardant | Flame retardant | Part by | 100.0 | 100.0 | 100.0 | 100.0 | 100.0 |
| rubber | silicone rubber | silicone rubber | weight | | | | | |
| composition | compound | compound A | | | | | | |
| | | Flame retardant | | | | | | |
| | | silicone rubber | | | | | | |
| | | compound B | | | | | | |
| | Flame retardant | Fibrous flame | | | | | | |
| | | retardant A | | | | | | |
| | | Fibrous flame | | | | | | |
| | | retardant B | | | | | | |
| | | Fibrous flame | | | | | | |
| | | retardant C | | | | | | |
| | | Phosphorus-based | | | 10.0 | 50.0 | | |
| | | flame retardant | | | | | | |
| | | Inorganic flame | | | | | 20.0 | 40.0 |
| | | retardant | | | | | | |
| | Curing agent | Curing agent A | | 1.3 | 1.3 | 1.3 | 1.3 | 1.3 |
| | | Curing agent B | | | | | | |
| Evaluation | Ordinary state | Shore A | Point | 58 | 63 | 76 | 69 | 76 |
| | | hardness | | | | | | |
| | Heat resistance | Permanent | % | 21 | — | — | — | — |
| | test | compression set | | | | | | |
| | Dispersibility | Evaluation | | 3 | 3 | 3 | 3 | 3 |
| | Burning test | Smoke | Second | 15 | 5 | 5 | 15 | 15 |
| | | occurrence time | | | | | | |
| | | Flame | | 15 | 5 | 30 | 30 | 30 |
| | | occurrence time | | | | | | |
| | | Flame duration | | 15 | Unmeasurable | Unmeasurable | 15 | 5 |

| | | | | | |
|---|---|---|---|---|---|
| Deformation | 2 | Unmeasurable | Unmeasurable | 1 | 1 |
| Appearance | 1 | 1 | 1 | 1 | 1 |

In the burning test in each of Comparative Examples 2 and 3, the test piece was completely burned, and thus it was impossible to measure the flame duration and the deformation.
In the burning test in each of Comparative Examples 4 and 5, the smoke occurrence time, the flame occurrence time, and the flame duration are equivalent to those in Examples, but the test piece after the burning test was extremely badly deformed and had very poor appearance.

### Result

Table 1 shows test results. A comparison between Examples 1 to 5 and Comparative Example 1 shows that the silicone rubber composition to which the fibrous flame retardant was added has higher flame retardancy. That is, the smoke occurrence time and the flame occurrence time were further delayed in Examples 1 to 5 than in Comparative Example 1. Further, the flame duration was shorter in Examples 1 to 5 than in Comparative Example 1.

Higher flame retardancy was observed also in a case where a type of the flame retardant silicone rubber compound was changed (Example 6). Similarly, higher flame retardancy was observed also in a case where a type of the fibrous flame retardant was changed (Examples 7 to 9). In Comparative Examples 2 and 3, in each of which the phosphorus-based flame retardant was added, on the contrary, a trend toward lower flame retardancy was observed. In Comparative Examples 4 and 5, in each of which the inorganic flame retardant was added, flame retardancy was equivalent to that in Examples, but deformation and appearance after the burning test were extremely poor.

A comparison among Examples has shown that a greater degree of improvement in flame retardancy was observed in Examples 2 to 5 than in Example 1. Thus, from the viewpoint of flame retardancy, the fibrous flame retardant is preferably contained in a larger amount than in Example 1 (for example, the fibrous flame retardant is contained in an amount of not less than 15 parts by weight relative to 100 parts by weight of the flame retardant silicone rubber compound).

Further, Shore A hardness in an ordinary state was lower in Examples 1 to 4 than in Example 5. Thus, from the viewpoint of use in a common sealing material, the fibrous flame retardant is preferably contained in a smaller amount than in Example 5 (for example, the fibrous flame retardant is contained in an amount of not more than 45 parts by weight relative to 100 parts by weight of the flame retardant silicone rubber compound).

The fibrous flame retardant A, the fibrous flame retardant B, and the fibrous flame retardant C are the most excellent (Examples 1 to 6), the second most excellent (Examples 7 and 8), and the third most excellent (Example 9), respectively, in dispersibility of the fibrous flame retardant in the silicone rubber composition. Thus, from the viewpoint of dispersibility, the fibrous flame retardant is preferably rock wool. Similarly, from the viewpoint of dispersibility, the fibrous flame retardant preferably has a low shot content (of, for example, not more than 0.5% by weight relative to a weight of the fibrous flame retardant).

### INDUSTRIAL APPLICABILITY

The present invention can be used for a sealing material for, for example, a battery.

### REFERENCE SIGNS LIST

1: Sealing material
2: Cell
3: Heat insulating material
4: Container
10: Battery

1. A sealing material silicone rubber composition comprising a flame retardant silicone rubber compound and a fibrous flame retardant,
the fibrous flame retardant being contained in an amount of 5 parts by weight to 60 parts by weight assuming that the flame retardant silicone rubber compound is contained in an amount of 100 parts by weight, and
the flame retardant silicone rubber compound being rated as V-0 or higher according to UL94 standard.

2. The sealing material silicone rubber composition as set forth in claim 1, wherein the fibrous flame retardant contains at least one selected from the group consisting of artificial mineral fiber, natural mineral fiber, and synthetic organic fiber.

3. The sealing material silicone rubber composition as set forth in claim 2, wherein
the fibrous flame retardant contains the artificial mineral fiber, and
the artificial mineral fiber contains rock wool.

4. The sealing material silicone rubber composition as set forth in claim 1, wherein the fibrous flame retardant has a fiber length of 50 μm to 500 μm and a shot content of not more than 5% by weight.

5. The sealing material silicone rubber composition as set forth in claim 1, wherein a content of the flame retardant silicone rubber compound in the sealing material silicone rubber composition is not less than 50% by weight.

6. The sealing material silicone rubber composition as set forth in claim 1, wherein the sealing material silicone rubber composition has Shore A hardness of not more than 85.

7. A sealing material comprising a sealing material silicone rubber composition recited in claim 1.

8. A battery comprising a plurality of cells, a heat insulating material, a container, and a sealing material recited in claim 7,
the container storing therein the plurality of cells, the heat insulating material, and the sealing material,
the heat insulating material being provided so as to divide an inside of the container into a plurality of sections,
the plurality of cells being separately provided in two or more of the plurality of sections, and
the sealing material being provided so as to close a gap between the heat insulating material and the container.
